(19) United States
(12) Patent Application Publication
(10) Pub. No.: US 2008/0308700 A1
(43) Pub. Date: Dec. 18, 2008

(54) Hanger of Overhead Projector

(75) Inventors: Hao-Chan Wei, Jen Te Hsian (TW); Ming-Jen Chan, Jen Te Hsian (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CHI LIN TECHNOLOGY CO., LTD., Jen Te Hsian (TW)

(21) Appl. No.: 11/934,319

(22) Filed: Nov. 2, 2007

Related U.S. Application Data
(60) Provisional application No. 60/944,112, filed on Jun. 15, 2007.

(51) Int. Cl. F16B 7/10

(52) U.S. Cl. 248/326; 248/324

(57) ABSTRACT

A hanger of an overhead projector as described. The hanger comprises a top pedestal, a suspension shaft disposed between first side plates of the top pedestal, a rotation pedestal connected to a lower end of the suspension shaft, a rotation pillar set in a circular hole of the rotation pedestal and a lower end of the suspension shaft, a universal joint shaft set between side plates of the rotation pedestal, and a bottom pedestal comprising two opposite side plates, wherein a lower end of the universal joint shaft is disposed between the side plates of the bottom pedestal. In the hanger, quick release devices are used to replace conventional fixing combinations each of which consists of a screw bolt and a screw nut to fix the top pedestal and the suspension shaft, the rotation pillar and the universal joint shaft, and the universal joint shaft and the bottom pedestal.

### RELATED APPLICATIONS

This application claims the priority benefit of U.S. Provisional Application Ser. No. 60/944,112, filed Jun. 15, 2007, which is herein incorporated by reference.

### FIELD OF THE INVENTION

The present invention relates to a hanger, and more particularly, to a hanger of an overhead projector.

### BACKGROUND OF THE INVENTION

In addition to providing a basic connection function to hang an overhead projector on a ceiling, a conventional hanger of the overhead projector further provides a multidirectional adjustment function to facilitate the adjustment of the image, so as to make the overhead projector accurately project on a screen. In the conventional hanger of the overhead projector, each of the adjustment elements of all directions in the conventional hanger mainly consists of a screw bolt and a screw nut. The adjustment is processed under the screw bolt is used as the pivot and the combination of the screw bolt and the screw nut is loosed, and after the completion of the adjustment, the state of the adjusted hanger is fixed by closely screwing the combination of the screw bolt and the screw nut. Although, the method can achieve the objective of the adjustment, some problems arising on the installation and the use need to be improved.

For example, the installation of the conventional hanger of the overhead projector is processed by an adjustment operation method by using a tool to loose or tighten the combination of the screw bolt and the screw nut, so that at least two workers are needed for the adjustment operation, wherein one worker holds the overhead projector while the other worker screws the combination of the screw bolt and the screw nut. As a result, the installation of the conventional hanger is inconvenient.

In addition, in the adjustment of the suspending altitude of the overhead projector, a slide is put around a shaft, and the shaft can move up and down with respect to the slide. Then, the suspending altitude of the overhead projector can be adjusted by setting one or more screw bolts in different position holes of the shaft. However, in such a hanger design, the adjusted altitude range is limited to the pitches of the position holes of the shaft, so that a stepless adjustment cannot be obtained, thereby being inconvenient in use.

In the adjustment of the angle of inclination of the overhead projector, the angle of inclination is adjusted by changing the fixed position of the screw bolt in a curve hole of an inclination pedestal. However, in such a hanger design, the angle that can be adjusted is limited to the length of the curve hole, so that an omnidirectional angle adjustment cannot be achieved, thereby being inconvenient in use.

### SUMMARY OF THE INVENTION

Therefore, one aspect of the present invention is to provide a hanger of an overhead projector, which can greatly increase the convenience of the installation and the adjustment of the hanger of an overhead projector.

Another aspect of the present invention is to provide a hanger of an overhead projector, wherein the adjustment operations of the hanger in all directions can be rapidly completed by one single person.

Still another aspect of the present invention is to provide a hanger of an overhead projector, which has a stepless adjustment function, so that the application of the hanger of an overhead projector is expanded.

According to the aforementioned objectives, the present invention provides a hanger of an overhead projector, comprising: a top pedestal comprising two opposite first side plates in a lower side of the top pedestal, wherein each first side plate includes a first circular hole and a first curve hole; a suspension shaft disposed between the first side plates, wherein the suspension shaft is set with at least two first through holes and at least two second through holes, a first screw bolt is set in the first circular holes and a first one of the first through holes, and a first quick release device is set in the first curve holes and a second one of the first through holes; a rotation pedestal connected to a lower end of the suspension shaft and comprising two opposite second side plates in a lower side of the rotation pedestal, wherein a top surface of the rotation pedestal is set with a second circular hole, and each second side plate is set with a thread hole and a third circular hole; a rotation pillar set in the second circular hole of the rotation pedestal and a lower end of the suspension shaft, wherein a bottom portion of the rotation pillar is fixed between the second side plates, the rotation pillar is set with two third through holes, two second screw bolts are respectively set in the second through holes and the third through holes to connect the suspension shaft and the rotation pillar, and two third screw bolts are respectively screwed into the thread holes of the rotation pedestal to fix the bottom portion of the rotation pillar; a universal joint shaft set between the second side plates of the rotation pedestal, wherein the universal joint shaft is set with a fourth through hole and a fifth through hole, and a second quick release device is set in the third circular holes and the fourth through hole; and a bottom pedestal comprising two opposite third side plates in an upper side of the bottom pedestal, wherein a lower end of the universal joint shaft is disposed between the third side plates, each third side plate is set with a fourth circular hole, and a third quick release device is set in the fourth circular holes and the fifth through hole.

According to a preferred embodiment of the present invention, each of the top pedestal, the rotation pedestal and the bottom pedestal is a one-piece structure.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawings, wherein:

FIG. 1 illustrates a diagram showing the assembly of a hanger of an overhead projector in accordance with a preferred embodiment of the present invention;

FIG. 2 illustrates a diagram showing the assembly of a hanger of an overhead projector in accordance with another preferred embodiment of the present invention;

FIG. 3 illustrates a diagram showing the both-sided adjustment of a hanger of an overhead projector in accordance with another preferred embodiment of the present invention;

FIG. 4 illustrates a diagram showing the altitude adjustment of a hanger of an overhead projector in accordance with another preferred embodiment of the present invention;

FIG. 5 illustrates a diagram showing the rotation adjustment of a hanger of an overhead projector in accordance with another preferred embodiment of the present invention;

FIG. 6 illustrates a diagram showing the oscillation adjustment of a hanger of an overhead projector in accordance with another preferred embodiment of the present invention; and

FIG. 7 illustrates a diagram showing the oscillation adjustment of a hanger of an overhead projector in accordance with another preferred embodiment of the present invention.

### DETAILED DESCRIPTION OF THE PREFERRED EMBODIMENT

In order to improve the various disadvantages of the conventional hanger of the overhead projector, the present invention provides a hanger of an overhead projector, which is composed of a hanger structure being easily installed and adjusted. In the hanger of the present invention, quick release devices are used to replace fixing combinations each of which consists of a screw bolt and a screw nut, so that the adjusting pivots in all directions can be rapidly loosed for adjustment and can be tightened after adjustment by pulling the stem of each quick release device by bare hands.

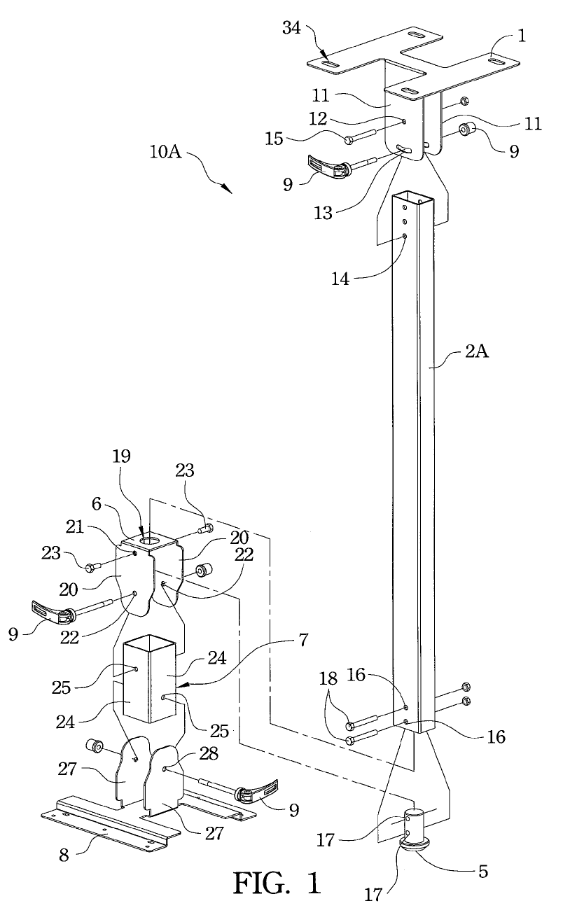

In an exemplary embodiment, referring to FIG. 1, a hanger 10A of an overhead projector mainly comprises a top pedestal 1, a suspension shaft 2A, a rotation pillar 5, a rotation pedestal 6, a universal joint shaft 7 and a bottom pedestal 8. The top pedestal 1 can be fixed on the place where the overhead projector desires to be suspended, such as a ceiling, wherein a plurality of fixing holes pass through a top surface of the top pedestal 1, and the a plurality of fixing elements, such as screws, can be set in the fixing holes to fix the hanger 10A of the overhead projector on the place where the overhead projector desires to be suspended. The top pedestal 1 includes two opposite side plates 11 folded downward, and each side plate 11 is set with a circular hole 12 and a curve hole 13. As shown in FIG. 1, the top pedestal 1 is preferably a one-piece structure, i.e. the top pedestal 1 is formed by folding a plate. However, the top pedestal 1 may be not a one-piece structure, for example, the side plates 11 are jointed to the body of the top pedestal 1 by soldering. In the present embodiment, the suspension shaft 2A may be a hollow rectangular column. The upper section of the suspension shaft 2A is set with at least two through holes 14, wherein the two through holes 14 are respectively corresponding to the circular hole 12 and the curve hole 13 of each side plate 11 of the top pedestal 1, wherein a screw bolt 15 can be pivoted in the circular hole 12 and the corresponding through hole 14, and a quick release device 9 can be set in the curve hole 13 and the corresponding through hole 14. The lower section of the suspension shaft 2A is set with two through holes 16. The location of the pivot of the quick release device 9 in the curve hole 13 can be adjusted by pulling the stem of the quick release device 9 set in the curve hole 13 of the top pedestal 1, and the suspension shaft 2A is rotated by removing the quick release device 9 to adjust the location of the suspension shaft 2A. After completing the location adjustment of the suspension shaft 2A, the stem of the quick release device 9 is pressed down to make the quick release device 9 closely bear the side plates 11 of the top pedestal 1 to fix the location of the suspension shaft 2A.

The rotation pillar 5 is set with two through holes 17, and the upper section of the rotation pillar 5 is inserted into the lower end of the suspension shaft 2A, wherein the through holes 17 of the rotation pillar 5 correspond to the through holes 16 on the lower section of the suspension shaft 2A, and two screw bolts 18 can be set in the corresponding through holes 16 and 17. The top surface of the rotation pedestal 6 is set with a circular hole 19, wherein the rotation pillar 5 can be pivoted in the circular hole 19. In addition, the rotation pedestal 6 further includes two opposite side plates 20 folded downward, and the bottom portion of the rotation pillar 5 can be fixed between the side plates 20 of the rotation pedestal 6. As shown in FIG. 1, the rotation pedestal 6 is preferably a one-piece structure, i.e. the rotation pedestal 6 is formed by folding a plate. Each side plate 20 of the rotation pedestal 6 is set with a thread hole 21 and a circular hole 22. Two screw bolts 23 can be respectively set in the thread holes 21 of the side plates of the rotation pedestal 6, wherein the bottom portion of the rotation pillar 5 can be closely held by the screw bolts 23 of the rotation pedestal 6. The rotation of the rotation pillar 5 can be controlled by adjusting the holding condition of the bottom portion of the rotation pillar 5 by the screw bolts 23.

As shown in FIG. 1, in the present embodiment, the universal joint shaft 7 may be a hollow rectangular column. Each set of two opposite side surfaces 24 of the universal joint shaft 7 is set with a set of two corresponding through holes 25, and the two sets of the corresponding through holes 25 are respectively disposed on the upper section and the lower section of the universal joint shaft 7, wherein the upper set of the through holes 25 correspond to the circular holes 22 of the rotation pedestal 6, and one quick release device 9 can be set in the through holes 25 and the corresponding circular holes 22. An overhead projector can be fixed to the bottom pedestal 8, wherein the bottom pedestal 8 includes two opposite side plates 27 folded upward. As shown in FIG. 1, the bottom pedestal 8 is preferably a one-piece structure, i.e. the bottom pedestal 8 is formed by folding a plate. The lower portion of the universal joint shaft 7 is sandwiched between the side plates 27. Each side plates 27 of the bottom pedestal 8 is set with a circular hole 28, wherein the circular holes 28 on the side plates of the bottom pedestal 8 respectively correspond to the through holes 25 on the lower section of the universal joint shaft 7, and a quick release device can be set in the circular holes 28 and the corresponding through holes 25.

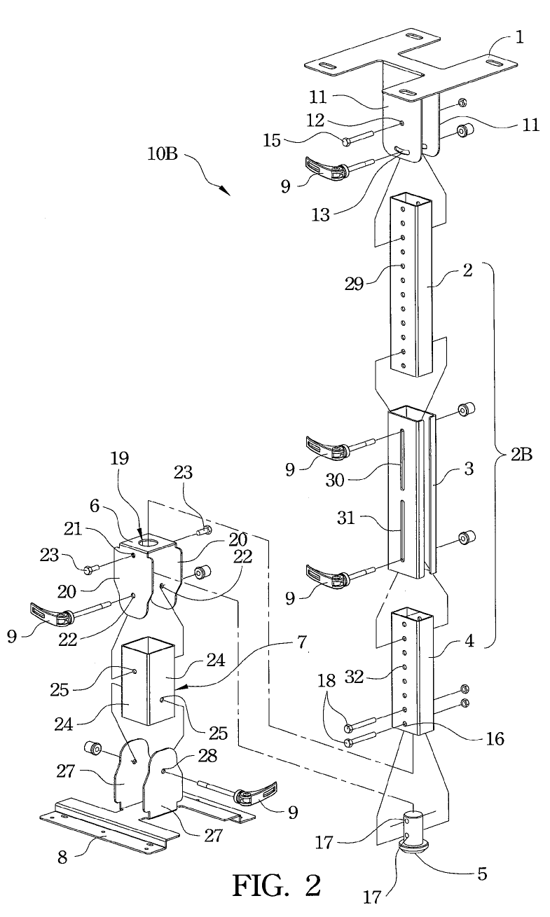

In a hanger 10B of an overhead projector of another exemplary embodiment, referring to FIG. 2, a suspension shaft set 2B can be used to replace the suspension shaft 2A described in the aforementioned exemplary embodiment. The suspension shaft set 2B is mainly composed of an upper suspension shaft 2, a slide 3 and a lower suspension shaft 4, wherein the upper suspension shaft 2 and the lower suspension shaft 4 can be movably slip within the slide 3. The upper end of the upper suspension shaft 2 is held between the opposite side plates 11 of the top pedestal 1. The upper suspension shaft 2 is set with a serial of equidistant through holes 29, wherein two of the through holes 29 on the upper section of the upper suspension shaft 2 respectively correspond to the circular hole 12 and the curve hole 13 on each side plate 11 of the top pedestal 1, wherein one screw bolt 15 is pivoted in the circular holes 12 and the corresponding through hole 29, and one quick release device 9 is set in the curve hole 13 and the corresponding through hole 29. The slide 3 is set with an upper slot hole 30 and a lower slot hole 31, wherein the upper slot hole 30 corresponds to one through hole 29 on the lower section of the upper suspension shaft 2, and one quick release device 9 can be set in the upper slot hole 30 and the corresponding through hole 29. Similar, the lower suspension shaft 4 is set with a serial of equidistant through holes 32, wherein one of the through holes 32 on the upper section of the lower suspension shaft 4 corresponds to the lower slot hole 31 of the slide 3, and one quick release device 9 can be set in the lower slot hole 31 and the corresponding through hole 32. In the present exemplary embodiment, the two through holes 17 set in the rotation pillar 5 respectively correspond to two of the through holes 32 on the lower section of the lower suspension shaft 4, wherein two screw bolts 18 are set in the two through holes 32 and the corresponding through holes 17.

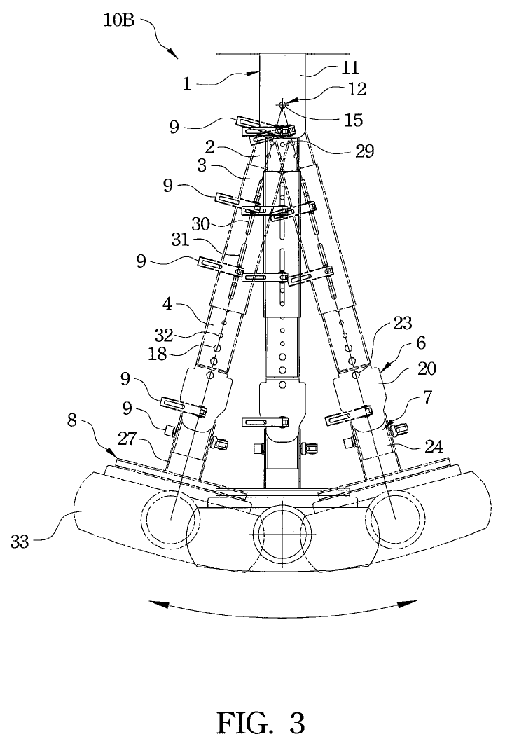

In the operation of the hanger 10A and the hanger 10B of an overhead projector described in the aforementioned exemplary embodiments, referring to FIG. 3, the quick release device 9 set in the curve holes 13 on the side plates 11 of the top pedestal 1 is relaxed, so that the angle adjustment on the left and right sides of the overhead projector 33 fixed to the bottom pedestal 8 can be achieved along the curve holes 13 on the side plates 11 of the top pedestal 1. After completing the adjustment, the quick release device 9 is tightened to fix the location of the quick release device 9 in the curve holes 13 of the top pedestal 1, so as to fix the location of the overhead projector 33.

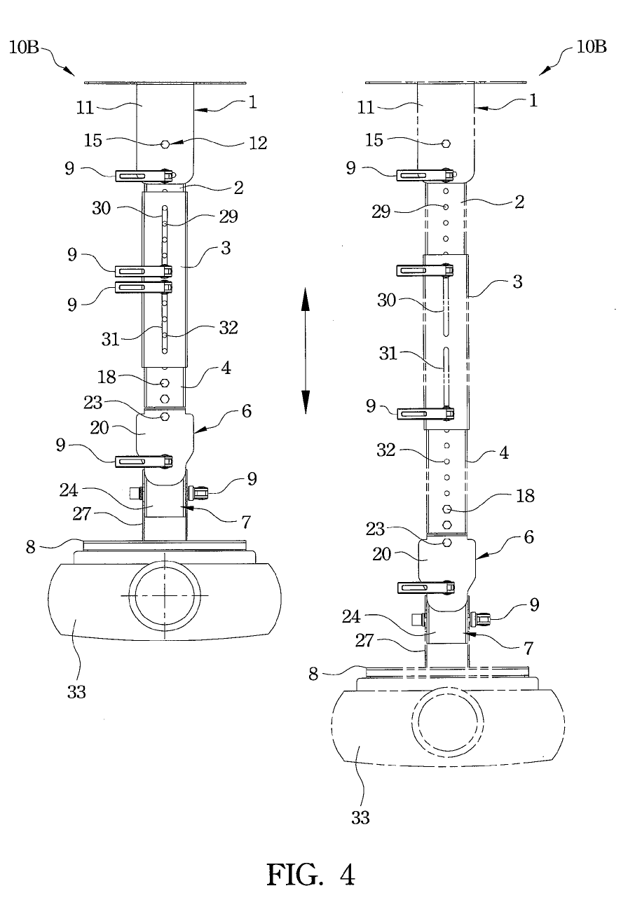

In the second exemplary embodiment, the suspension shaft set 2B can be utilized to adjust the altitude of the overhead projector. As shown in FIG. 4, the quick release devices 9 in the upper slot hole 30 and the lower slot hole 31 of the slide 3 are relaxed, the upper suspension shaft 2 and the lower suspension shaft 4 can respectively slip upward and downward in the slide 3 along the upper slot hole 30 and the lower slot hole 31, so that the suspension altitude of the overhead projector 33 can be adjusted. After completing the adjustment, the quick release devices 9 are tightened and fixed so as to fix the adjusted altitude of the overhead projector 33. The slide 3 is set with two slot holes 30 and 31, and the quick release devices 9 can be selectively plugged into various through holes 29 on the upper suspension shaft 2 and various through holes 32 on the lower suspension shaft 4 respectively, so that the hanger 10B can provide a stepless adjustment function and cannot be limited to the pitches between the through holes on the upper suspension shaft 2 and the lower suspension shaft 4.

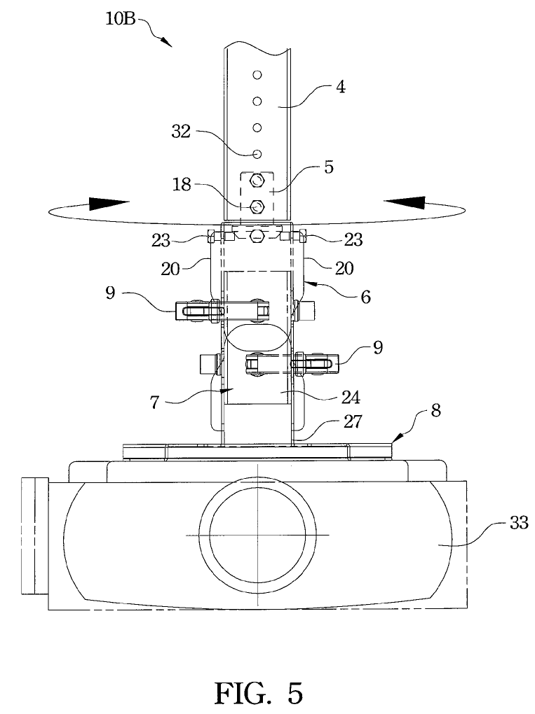

Furthermore, in the aforementioned embodiments, as shown in FIG. 5, the screw bolts 23 set in the thread holes 21 of the side plates 20 of the rotation pedestal 6 are loosed to set free the rotation pillar 5, so that the rotation pedestal 6 can rotate around the rotation pillar 5 to adjust the horizontal rotation angle of the overhead projector 33 in 360 degrees. After completing the adjustment, the screw bolts 23 are tightened and fixed to hold the rotation pillar 5.

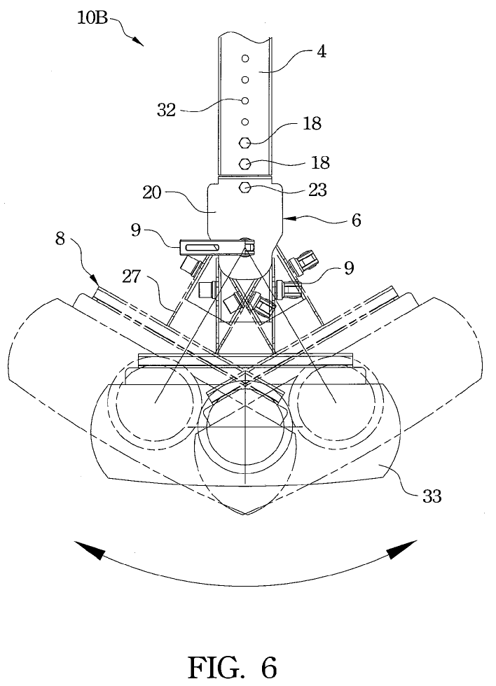

As shown in FIG. 6, in the hanger 10B of the overhead projector, the quick release device 9 set in the circular holes 22 on the side plates 20 of the rotation pedestal 6 is loosed, and the combination of the universal joint shaft 7 and the bottom pedestal 8 can oscillate to the left and right sides relative to the rotation pedestal 6, so that the both-sided angle adjustment of the overhead projector 33 can be achieved. After the completing the adjustment, the quick release device 9 is tightened to fix the relative location of the universal joint shaft 7 and the rotation pedestal 6.

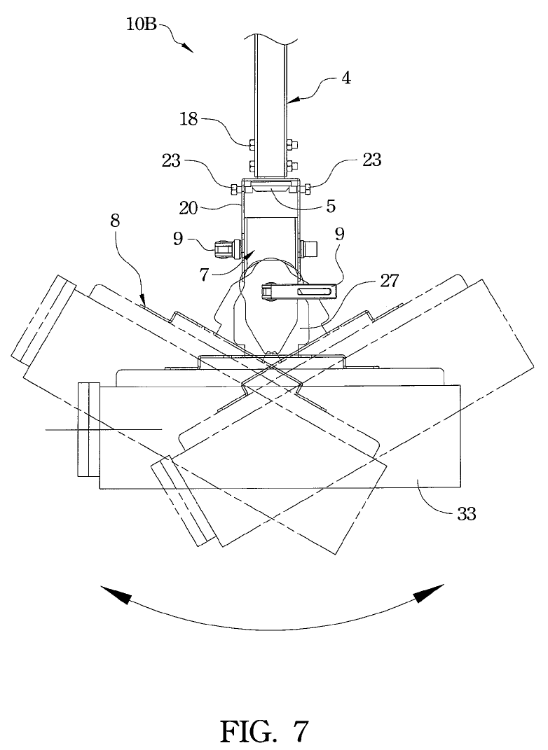

As shown in FIG. 7, the quick release device 9 set in the circular holes 28 on the side plates 27 of the bottom pedestal 8 is loosed, and the bottom pedestal 8 can oscillate to the front and rear relative to the universal joint shaft 7, so that the front and rear angle adjustment of the overhead projector 33 fixed to the bottom pedestal 8 can be achieved. After completing the adjustment, the quick release device 9 is tightened to fix the relative location of the bottom pedestal 8 and the universal joint shaft 7.

According to the aforementioned assembly design, the exemplary embodiments of the present invention include the following advantages. In the aforementioned exemplary embodiments, quick release devices are used to replace combinations of screw bolts and screw nuts, so that one operator can complete the adjustment with one hand holding and adjusting the overhead projector and the other hand pulling the quick release device, and the adjustment is operated without any tools. Therefore, with the application of the hangers in the exemplary embodiments, the adjustment and the installation of the overhead projector is simple and easy.

Furthermore, a stepless adjustment effect of the suspension altitude of the overhead projector can be achieved by adjusting the suspension altitude of the overhead projector with the using of slot holes of a slide, so that the hanger of the overhead projector of the present invention is more convenient and practical for use comparing with the conventional hanger of the overhead projector which can merely be adjusted according to the fixed pitch.

Moreover, the omnidirectional angle adjustment of the overhead projector can be achieved with the pivot designs between the universal joint shaft and the rotation pedestal, and the universal joint shaft and bottom pedestal, so that the hanger of the overhead projector of the present invention has great application comparing to the conventional hanger of the overhead projector which can be only adjusted within a small angle range.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A hanger of an overhead projector, comprising:
a top pedestal comprising two opposite first side plates in a lower side of the top pedestal, wherein each first side plate includes a first circular hole and a first curve hole;
a suspension shaft disposed between the first side plates, wherein the suspension shaft is set with at least two first through holes and at least two second through holes, a first screw bolt is set in the first circular holes and a first one of the first through holes, and a first quick release device is set in the first curve holes and a second one of the first through holes;
a rotation pedestal connected to a lower end of the suspension shaft and comprising two opposite second side plates in a lower side of the rotation pedestal, wherein a top surface of the rotation pedestal is set with a second circular hole, and each second side plate is set with a thread hole and a third circular hole;
a rotation pillar set in the second circular hole of the rotation pedestal and a lower end of the suspension shaft, wherein a bottom portion of the rotation pillar is fixed between the second side plates, the rotation pillar is set with two third through holes, two second screw bolts are respectively set in the second through holes and the third through holes to connect the suspension shaft and the rotation pillar, and two third screw bolts are respectively screwed into the thread holes of the rotation pedestal to fix the bottom portion of the rotation pillar;
a universal joint shaft set between the second side plates of the rotation pedestal, wherein the universal joint shaft is set with a fourth through hole and a fifth through hole, and a second quick release device is set in the third circular holes and the fourth through hole; and
a bottom pedestal comprising two opposite third side plates in an upper side of the bottom pedestal, wherein a lower end of the universal joint shaft is disposed between the third side plates, each third side plate is set with a fourth circular hole, and a third quick release device is set in the fourth circular holes and the fifth through hole.

2. The hanger of an overhead projector according to claim 1, wherein the top pedestal is a one-piece structure.

3. The hanger of an overhead projector according to claim 1, wherein a top surface of the top pedestal is set with a plurality of fixing holes passing through the top surface of the top pedestal.

4. The hanger of an overhead projector according to claim 1, wherein the suspension shaft is a hollow rectangular column.

5. The hanger of an overhead projector according to claim 1, wherein the rotation pedestal is a one-piece structure.

6. The hanger of an overhead projector according to claim 1, wherein the universal joint shaft is a hollow rectangular column.

7. The hanger of an overhead projector according to claim 1, wherein the bottom pedestal is a one-piece structure.

8. A hanger of an overhead projector, comprising:
a top pedestal comprising two opposite first side plates in a lower side of the top pedestal, wherein each first side plate includes a first circular hole and a first curve hole;
an upper suspension shaft disposed between the first side plates, wherein the upper suspension shaft is set with a plurality of first through holes, a first screw is set in the first circular holes and a first one of the first through holes, and a first quick release device is set in the first curve holes and a second one of the first through holes;
a lower suspension shaft disposed under the upper suspension shaft and set with a plurality of second through holes;
a slide, wherein the upper suspension shaft and the lower suspension shaft can be movably slip within the slide, the slide is set with an upper slot hole and a lower slot hole passing through the slide, a second quick release device is set in the upper slot hole and a third one of the first through holes, and a third quick release device is set in the lower slot hole and a first one of the second through holes;
a rotation pedestal connected to a lower end of the lower suspension shaft and comprising two opposite second side plates in a lower side of the rotation pedestal, wherein a top surface of the rotation pedestal is set with a second circular hole, and each second side plate is set with a thread hole and a third circular hole;
a rotation pillar set in the second circular hole of the rotation pedestal and a lower end of the lower suspension shaft, wherein a bottom portion of the rotation pillar is fixed between the second side plates, the rotation pillar is set with two third through holes, two second screw bolts are respectively set in two second ones of the second through holes and the third through holes to connect the lower suspension shaft and the rotation pillar, and two third screw bolts are respectively screwed into the thread holes to fix the bottom portion of the rotation pillar;
a universal joint shaft set between the second side plates of the rotation pedestal, wherein the universal joint shaft is set with a fourth through hole and a fifth through hole, and a fourth quick release device is set in the third circular holes and the fourth through hole; and
a bottom pedestal comprising two opposite third side plates in an upper side of the bottom pedestal, wherein a lower end of the universal joint shaft is disposed between the third side plates, each third side plate is set with a fourth circular hole, and a fifth quick release device is set in the fourth circular holes and the fifth through hole.

9. The hanger of an overhead projector according to claim 8, wherein the first through holes are arranged in equidistance.

10. The hanger of an overhead projector according to claim 8, wherein the second through holes are arranged in equidistance.

11. The hanger of an overhead projector according to claim 8, wherein the top pedestal is a one-piece structure.

12. The hanger of an overhead projector according to claim 8, wherein a top surface of the top pedestal is set with a plurality of fixing holes passing through the top surface of the top pedestal.

13. The hanger of an overhead projector according to claim 8, wherein the upper suspension shaft is a hollow rectangular column.

14. The hanger of an overhead projector according to claim 8, wherein the lower suspension shaft is a hollow rectangular column.

15. The hanger of an overhead projector according to claim 8, wherein the rotation pedestal is a one-piece structure.

16. The hanger of an overhead projector according to claim 8, wherein the universal joint shaft is a hollow rectangular column.

17. The hanger of an overhead projector according to claim 8, wherein the bottom pedestal is a one-piece structure.
